(19) United States
(12) Patent Application Publication
(10) Pub. No.: US 2003/0136411 A1
(43) Pub. Date: Jul. 24, 2003

(54) Portable life mask

(76) Inventor: Ming-Mei Hsieh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/354,056

(22) Filed: Jan. 30, 2003

Related U.S. Application Data
(63) Continuation-in-part of application No. 09/897,101, filed on Jul. 3, 2001.

(51) Int. Cl. A62B 18/08

(52) U.S. Cl. 128/206.25

(57) ABSTRACT

A portable life mask for helping an user to escape from the fire, gas or other toxic air emergencies with a pocket size after folded. The mask has a incombustible transparent bag body which having a front and a rear sheet, the front sheet connected with the rear sheet so that defined a cavity and an opening, an stretchable annulus connected to the opening of the bag body through which a head of the user can be placed in, a general rectangular filter composed with a plurality of filtering layers, a plurality of holes formed on the front sheet, the filter disposed around said holes of said front sheet with a plurality of adhesive strips, and an one-way breathing means disposed on a middle of the filter for be held in a mouth of the user so that breathe out easily.

### CROSS-REFERENCE TO RELATED APPLICATIONS

This application is a Continuation-in-Part of application Ser. No. 09/897,101, filed on Jul. 3, 2002, and entitles MODIFIED LIFE MASK.

### BACKGROUND OF THE INVENTION

1. Field of the Invention

The present invention relates to a portable life mask and, more particularly, to a light and portable life mask, which has a wide field of view for reducing the respiratory health risks and mortality rates and can filter various toxic gases in the fire, gas or other toxic air emergencies.

2. Description of the Related Prior Art

Life equipment in prior art can protect the user's face through a mask to help the user escape from dangerous sites when hazards such as fire disasters happened. However, there are some problems of a life mask in prior art. For instance, it usually occupies much space and cannot be taken along conveniently, the general public has not used them. Also, filtering plates and pots need to be replaced constantly. Moreover, the operation is cumbersome, resulting in inconvenient use. Therefore, it has not been widely used for reducing casualties resulted from fire disasters.

Especially, a life mask in prior art cannot achieve better protection effect when used. FIG. 6 shows a state of use of a life mask in prior art. As shown in this figure, a viewing means 7 limits the field of vision, a cover 6 and a filtering device 8 of the life mask can not stick tightly to the mouth and nose of the user, and can not apply to people of various ages and habitus.

Therefore, although a life mask can mask the user's face, it can not discharge carbon dioxide breathed out and filter toxic gases pervasive in the fire site to let the user breathe air containing oxygen. Moreover, because there will be excess carbon dioxide in the life mask, the escaping time will be reduced, resulting in little escaping opportunity.

### SUMMARY OF THE INVENTION

The primary object of the present invention is to provide a portable life mask, which can be stick tightly placed on a head of the user when hazards such as fire disasters happen. A filter of the portable life mask can be positioned around the mouth and nose of the user so as to filter various toxic gases pervasive in the fire site, and to discharge carbon dioxide to prevent the user from breathing excess carbon dioxide. The user can thus breathe filtered air directly. Further, the invention has a one-way breathing means disposed on a middle of the filter for held in the mouth of the user so that breathe out more easily. The present invention can prevent the hair and face of the user from scathe, and can prevent the smoke from getting into the eyes with the transparent bag body so that the user can see escaping paths clearly. Therefore, the escaping opportunity of the user will be greatly increased.

Another object of the present invention is to provide a portable life mask, which can reflect thermal radiation and resist high temperature so as to keep the user in sobriety. The portable life mask of the present invention applies to various kinds of people, and its operation is simple. Moreover, the present invention does not occupy much space after folded, and can be taken along and stored conveniently.

In order to achieve the object set forth, the portable life mask of the present invention comprises a incombustible transparent bag body having a front and a rear sheet, said front sheet connected with said rear sheet so that defined a cavity and an opening, an stretchable annulus connected to said opening of said bag body through which a head of the user can be placed for wearing the mask over the head, a general rectangular filter composed with a plurality of filtering layers, a plurality of holes formed on the front sheet, said filter disposed around said holes of said front sheet with a plurality of adhesive strips, and an one-way breathing means disposed on a middle of said filter for be held in a mouth of the user so that breathe out easily, in which said annulus is for strictly put around the user's neck.

The various objects and advantages of the present invention will be more readily understood from the following detailed description when read in conjunction with the appended drawings, in which:

### BRIEF DESCRIPTION OF DRAWING

FIG. 1 is an exploded perspective view of the present invention;

FIG. 1A is enlarged perspective view of the A part in the FIG. 1;

FIG. 2 is a perspective view of the filter of the present invention;

FIG. 2A is a cross sectional view taken along the line 2A;

FIG. 3 is a assembled perspective view of the invention;

FIG. 4 is a perspective view which showing a using state of the present invention;

FIG. 5 is a side view of FIG. 4; and

FIG. 6 is a side view of a life mask in prior art.

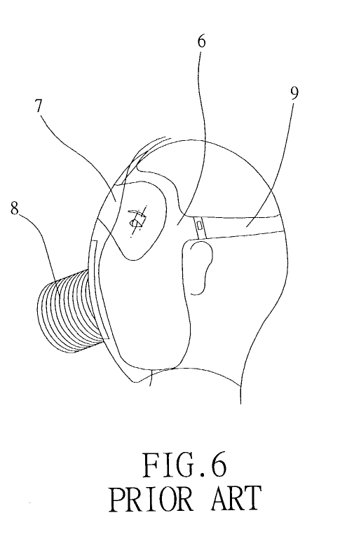

### DETAILED DESCRIPTION OF PREFERRED EMBODIMENT

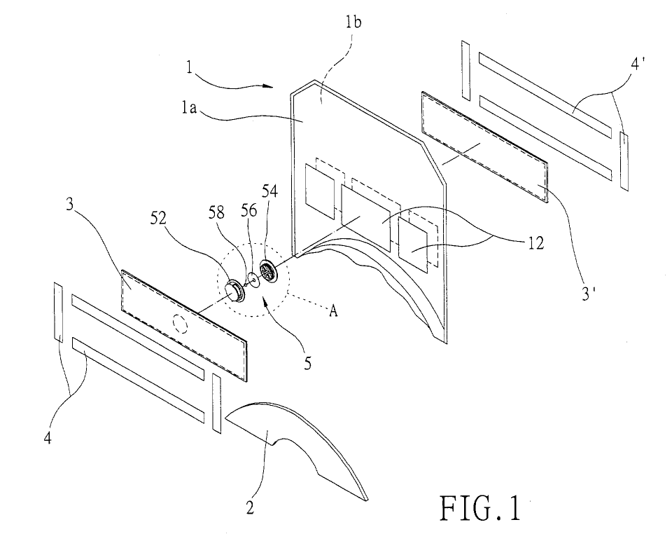

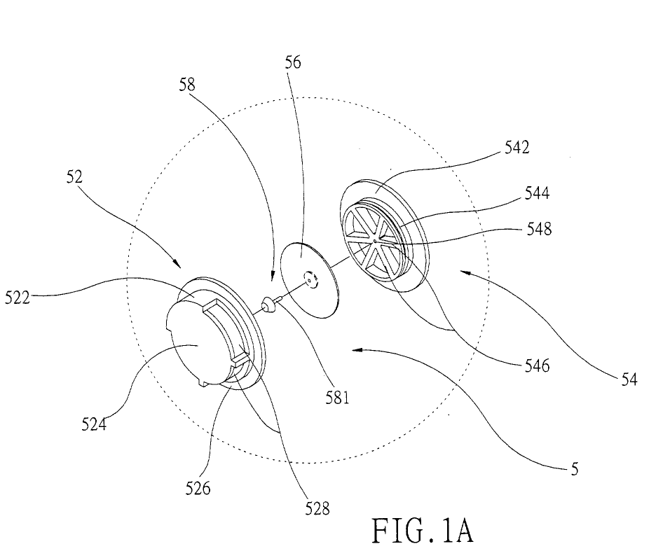

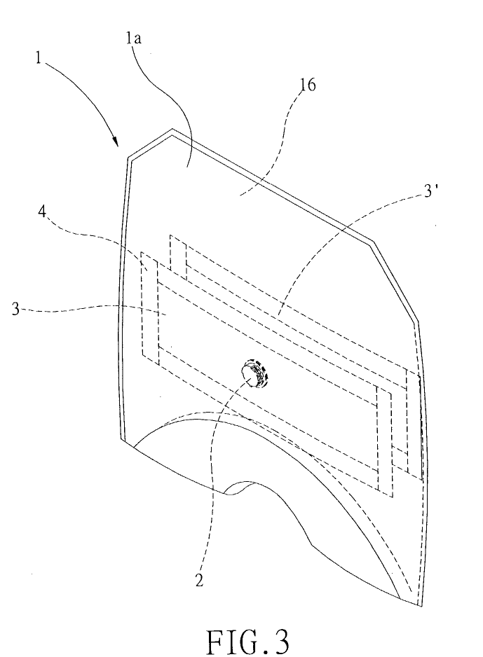

As shown in FIGS. 1, 1A, 2, and 3, a portable life mask of the present invention comprises a incombustible transparent bag body 1, an stretchable annulus 2, a filter 3, and a breathing means 5.

The bag body 1 is a transparent bag, which has a good transparency and can resist temperature higher than 450° C., such as a kind of incombustible film product by the Du Pont Company. The bag body 1 can protect the face, eyes, and hair of the user. The bag body 1 having a front sheet 1a and a rear sheet 1b, said front sheet 1a connected with said rear sheet so that defined a cavity and an opening.

The stretchable annulus 2 is installed at the opening of the main body 1. The stretchable annulus 2 is made of contractible material with good contractility and heat resistance. Through which the head of the user can be placed for wearing the mask over the head.

The filter 3 is general rectangular, and having a plurality of filtering layers, a plurality of holes 12 formed on the front sheet 1a, the filter 3 disposed around the holes 12 of the front sheet 1a with a plurality of adhesive strips 4.

The one-way breathing means 5 only allowed a airflow flow out. The breathing means 5 is disposed on a middle of the filter 3 for be held in a mouth of the user so that breathe out easily. The breathing means 3 has a box body 52 having an annular wall 522, a bottom 524 connected to the annular wall 522, and an apron 526 extended from the annular wall 522, the annular wall formed a plurality of downward or sideward slots 528, a circle flexible film 56, and a inner body 54 engaged in the box body 52, the inner body 54 having a ring 542, a retainer 544, and a plurality of radial ribs 546 formed therein and defined a center hole 548, the radial ribs 548 tilted from a circumference to a center thereof, thereby the retainer 544 engaged in the center hole 548 and held the film 56 on the inner body 54. The rectangular filter 3 has a through hole 30 formed thereon corresponding the inner body 54, so that the inner body 54 could being disposed in the hole 30 of the filter 3, and the box body 52 clipped the filter layers outside with the inner body 54.

The downward or sideward slots 528 on the annular wall 522 of the box body 52 allowing the user breathing out.

Another embodiment of the present invention, the rear sheet 1b further has a rectangular filter 3′ disposed thereon for increasing a breathing flow exhausted easily.

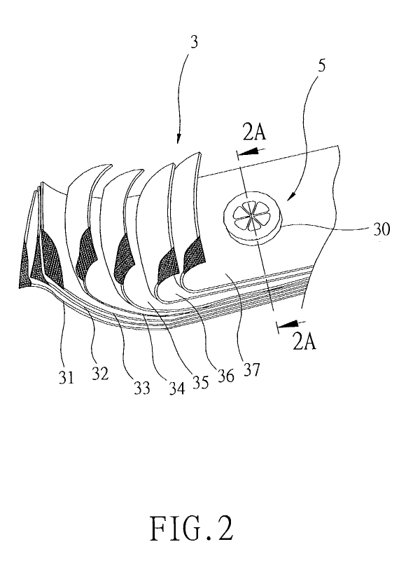

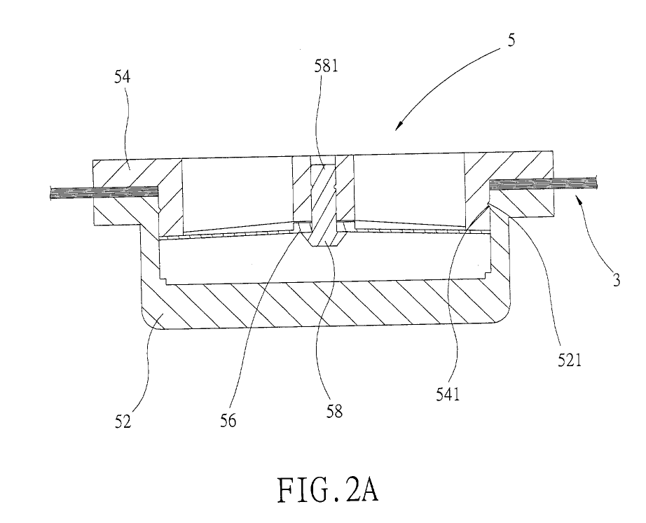

Referring the FIG. 2, the filter 3 is a multi-layer structure and is composed of at least an oxidized fiber fire-resistant cloth 31,37, an active carbon unwoven cloth 32, 35, an active carbon fiber cloth 34, and a P.P. unwoven cloth 33, 36. The filter 3 can repeatedly filter and absorb toxic gases. The filter 3 also has the effect of catalyzing transformation. Moreover, the comfort of contacting with the user's face is also considered. Better protection effect of the life mask can thus be achieved.

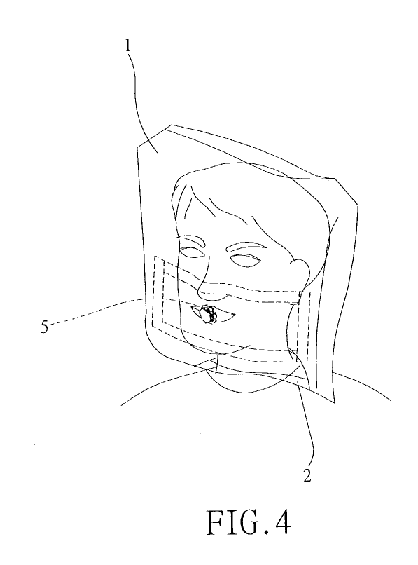

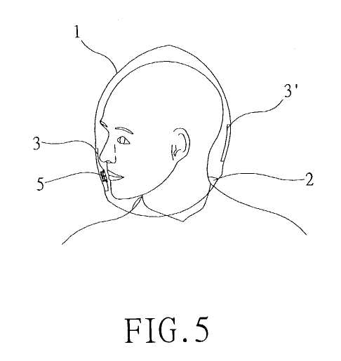

As shown in FIGS. 4 and 5, when a fire disaster happens, the stretchable annulus 2 at the bottom end of the main body 1 is unfolded. The life mask is then telescoped from the top of the user's head and adjusted so that the filter 3 is in front of the user's nose. Thereby the life mask can protect the user's face so as to increase the escaping time.

Because the stretchable annulus 2 can be stretched, the life mask can be easily telescoped on the user's head. The present invention also has the advantages of occupying less space after folded, easy operation, portability, and convenient storing so that it can be widely used.

Although the present invention has been described with reference to the preferred embodiments thereof, it will be understood that the invention is not limited to the details thereof Various substitutions and modifications have suggested in the foregoing description, and other will occur to those of ordinary skill in the art. Therefore, all such substitutions and Modifications are intended to be embraced within the scope of the invention as defined in the appended claims.

I claim:

1. A portable life mask for helping an user to escape from the fire, gas or other toxic air emergencies with a pocket size after folded, comprising
a incombustible transparent bag body having a front and a rear sheet, said front sheet connected with said rear sheet so that defined a cavity and an opening, an stretchable annulus connected to said opening of said bag body through which a head of the user can be placed for wearing the mask over the head, a general rectangular filter composed with a plurality of filtering layers, a plurality of holes formed on the front sheet, said filter disposed around said holes of said front sheet with a plurality of adhesive strips, and an one-way breathing means disposed on a middle of said filter for be held in a mouth of the user so that breathe out easily, in which said annulus is for strictly put around the user's neck.

2. The portable life mask of claim 1 wherein the one-way breathing means comprises:
a box body having an annular wall, a bottom connected to said annular wall, and an apron extended from the annular wall, the annular wall formed a plurality of downward or sideward slots;
a circle flexible film; and
a inner body engaged in said box body, said inner body having a ring, a retainer, and a plurality of radial ribs formed therein and defined a center hole, said radial ribs tilted from a circumference to a center thereof, thereby the retainer engaged in the center hole and held the film on the inner body, wherein the rectangular filter formed a through hole corresponding the inner body for the inner body being disposed on the filter, and the box body clipped the filter layers outside with the inner body; whereby
the downward or sideward slots on the annular wall of the box body allowing the user breathing out.

3. The portable life mask of claim 1 wherein the rear sheet further has a rectangular filter disposed thereon for increasing a breathing flow exhausted easily.
